(19) United States
(12) Patent Application Publication
(10) Pub. No.: US 2016/0337738 A1
(43) Pub. Date: Nov. 17, 2016

(54) HEADPHONE COVER

(71) Applicant: DEXERIALS CORPORATION, Tokyo (JP)

(72) Inventor: Masayuki Hayashi, Fuchu-Shi, Tokyo (JP)

(21) Appl. No.: 15/111,319

(22) PCT Filed: Oct. 20, 2015
(86) PCT No.: PCT/JP2015/077800

§ 371 Date: Jul. 13, 2016

(30) Foreign Application Priority Data
Oct. 15, 2014 (JP) 2014-210727

(51) Int. Cl. H04R 1/10

(52) U.S. Cl. CPC H04R 1/10

(57) ABSTRACT

In a headphone cover obtained by folding a peripheral edge portion 11 of an elastic fabric 10 to a back side over an entire periphery and forming an opening portion 12 on the back side, an elastic webbing 20 is sewn to the fabric in an opening peripheral edge portion corresponding to a peripheral edge of the opening portion 12. Consequently, it is not necessary to cover a periphery of a rubber with the fabric in order to hold the rubber as in the related art. Thus, the fabric 20 can be prevented from being broken due to deterioration caused by a friction in the opening peripheral edge portion of the headphone cover.

### TECHNICAL FIELD

The present invention relates to a headphone cover to be used with an ear pad of a headphone covered.

### BACKGROUND ART

Conventionally, there is provided a headphone cover (which is also referred to as an ear pad) to be used with an ear pad of a headphone covered (for example, see Patent Document 1). As described in the Patent Document 1, the conventional headphone cover is configured by putting a rubber on the vicinity of a peripheral edge portion of an elastic fabric and folding the peripheral edge portion of the fabric back to cover the rubber with the fabric, thereby sewing the peripheral edge portion of the fabric cylindrically in this state.

However, the headphone cover is usually formed by a thin fabric in order to easily perform passage of a sound. For this reason, the fabric tends to be deteriorated due to a friction caused by daily use. In an opening peripheral edge portion of the headphone cover covering a rubber with a fabric, particularly, there is a problem in that the fabric tends to be broken due to deterioration caused by a friction.

Moreover, the ear pad of the headphone has various sizes and headphone covers of various types are usually prepared corresponding to the sizes. Although an elastic fabric or rubber is used, a thread to be used for sewing the peripheral edge portion covering the rubber has a limit of expansion and contraction. For this reason, it is impossible to use the headphone cover in a headphone having a size which exceeds a limit of the expansion of the thread. Therefore, there is a problem in that headphone covers having a large number of sizes should be prepared corresponding to headphones having various sizes.

Patent Document 1: Japanese Laid-Open Utility Model Publication No. 1985-176719

### DISCLOSURE OF THE INVENTION

The present invention has been made to solve these problems and has an object to enable prevention of breakage of a fabric which is caused by deterioration due to a friction in an opening peripheral edge portion of a headphone cover.

Moreover, it is an object of the present invention to enable use of a headphone cover of a single type in headphones having as many sizes as possible.

In order to attain the objects, the present invention provides a headphone cover obtained by folding a peripheral edge portion of an elastic fabric back to one of surface sides over an entire periphery and forming an opening portion on the one of surface sides, in which an elastic webbing is sewn, with a thread, to a fabric in an opening peripheral edge portion corresponding to a peripheral edge of the opening portion.

In another aspect of the present invention, a length of a thread to be used for sewing is set to be greater than a length of an entire periphery in a state in which an elastic webbing is contracted most greatly.

According to the present invention having the structure described above, the elastic webbing is sewn to the opening peripheral edge portion of the headphone cover. Therefore, it is not necessary to cover a periphery of a rubber with a fabric in order to hold the rubber as in the related art. Consequently, the opening peripheral edge portion of the headphone cover is formed by the elastic webbing which has a higher resistance to a friction than a thin fabric. Thus, the fabric can be prevented from being broken due to deterioration caused by the friction in the opening peripheral edge portion.

According to another feature of the present invention, moreover, the thread is loosened in a state in which the elastic webbing is contracted most greatly (is not expanded) so that there is a margin for expansion from a state in which the thread is loosened to a state in which the thread is not loosened. Correspondingly, the elastic webbing can be expanded beyond a limit of the expansion of the thread itself. Consequently, it is possible to use a headphone cover of a single type in headphones having as many sizes as possible.

### BRIEF DESCRIPTION OF THE DRAWINGS

FIG. 1 is a plan view showing an example of a structure of a headphone cover according to the present embodiment.

FIG. 2 is a bottom view showing an example of the structure of the headphone cover according to the present embodiment.

FIG. 3 is a side view showing an example of the structure of the headphone cover according to the present embodiment.

### BEST MODE FOR CARRYING OUT THE INVENTION

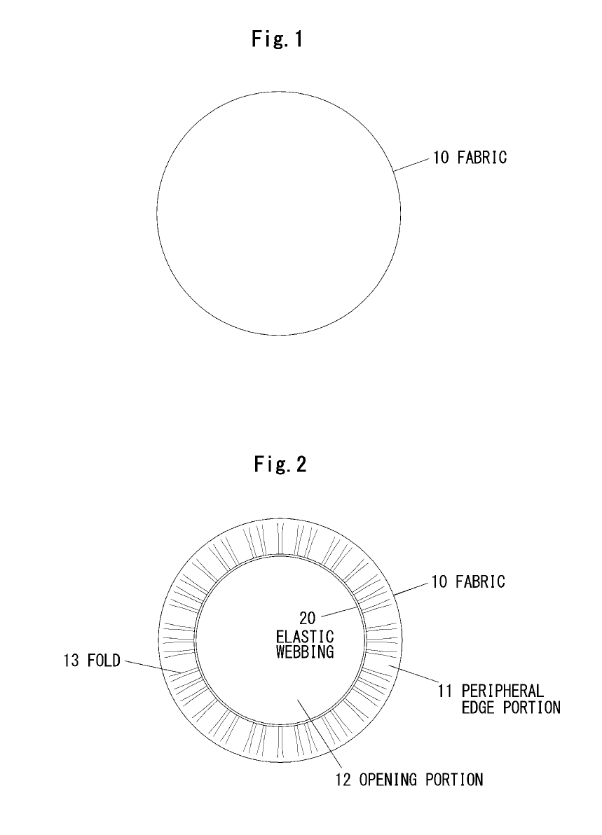

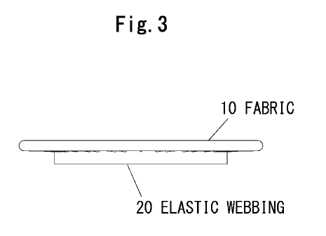

An embodiment of the present invention will be described below with reference to the drawings. FIGS. 1 to 3 are views showing an example of a structure of a headphone cover according to the present embodiment, and FIG. 1 is a plan view, FIG. 2 is a bottom view and FIG. 3 is aside view. The headphone cover according to the present embodiment has elasticity and can be deformed and FIGS. 1 to 3 show a shape of the headphone cover in a steady state in which external force is not applied.

As shown in FIGS. 1 to 3, the headphone cover according to the present embodiment has a structure in which a peripheral edge portion 11 of an elastic fabric 10 taking a circular shape is folded back from a plane side (a surface side) to a bottom face side (a back side) over an entire periphery to form an opening portion 12 on the bottom face side. An ear pad of a headphone is inserted from the opening portion 12 so that the ear pad of the headphone is covered with the headphone cover.

The headphone cover according to the present embodiment has a structure in which an elastic webbing 20 is sewn, with a thread, to the fabric of an opening peripheral edge portion corresponding to a peripheral edge of the opening portion 12, that is, an end of the circular fabric 10 folded back. It is preferable that the thread to be used herein should have elasticity. The elastic webbing 20 is used because sewing to the fabric 10 can be performed more easily than a round rubber.

A length of the thread to be sewn is set to be greater than a length of the entire periphery in a state in which the elastic webbing 20 is contracted most greatly (a length of a circumference of the elastic webbing 20 in a steady state shown in FIG. 2). Then, the thread is sewn in almost parallel with a longitudinal direction (a circumferential direction) of the elastic webbing 20. Specifically, the elastic webbing 20 is brought into an expanding state to sew the end of the fabric 10 in a non-expanding state and the elastic webbing 20 together.

Moreover, a size is set in such a manner that the length of the circumference of the end of the fabric 10 in the non-expanding state is greater than the length of the circumference of the elastic webbing 20 in the non-expanding state. When the elastic webbing 20 is sewn to the fabric 10 in the expanding state and the expansion is then stopped to return into the steady state shown in FIG. 2, consequently, there is brought a state in which the peripheral edge portion 11 of the fabric 10 is contracted by force of the elastic webbing 20 so that folds 13 are generated. In other words, the elastic webbing 20 is sewn with the peripheral edge portion 11 of the fabric 10 loosened.

In the headphone cover according to the present embodiment, thus, the elastic webbing 20 is sewn to the opening peripheral edge portion of the headphone cover. Therefore, it is not necessary to cover a circumference of a rubber with a fabric in order to hold the rubber as in the related art. Consequently, the opening peripheral edge portion of the headphone cover is formed by the elastic webbing 20 having a higher resistance to a friction than the thin fabric 10 so that the fabric 10 can be prevented from being broken due to deterioration caused by the friction in the opening peripheral edge portion.

In the present embodiment, moreover, the length of the thread to be used for the sewing is set to be greater than the length of the entire periphery of the elastic webbing 20 in the steady state. Therefore, the thread is loosened in a state in which the elastic webbing 20 is contracted most greatly (is not expanded) so that there is a margin for expansion from the loosing state of the thread to a non-loosing state thereof. Correspondingly, the elastic webbing 20 can be expanded beyond a limit of the expansion of the thread itself. Consequently, it is possible to use a headphone cover of a single type in headphones having as many sizes as possible.

Although the description has been given to the example in which the shape of the fabric 10 is a circle in the embodiment, the present invention is not restricted thereto. For example, the shape of the fabric 10 may be an ellipse, a triangle, a square or a polygon such as a pentagon or more.

Although the description has been given to the example in which the end of the fabric 10 and the elastic webbing 20 are sewn together with the elastic webbing 20 expanded in the embodiment, moreover, a sewing way is not restricted thereto. For example, the end of the peripheral edge of the fabric 10 may be loosened like pleats and sewn with the thread loosened in a state in which the elastic webbing 20 is not expanded but contracted.

Although the description has been given to the example in which the thread is sewn in almost parallel with the longitudinal direction of the elastic webbing 20 in the embodiment, furthermore, the present invention is not restricted thereto. For example, the thread may be sewn in zigzags at a predetermined angle in the longitudinal direction of the elastic webbing 20. Consequently, it is possible to more increase a difference between the length of the thread to be sewn and the length of the entire periphery in a state in which the elastic webbing 20 is contracted most greatly.

Although the description has been given to the example in which the size is set in such a manner that the length of the circumference of the end of the fabric 10 in the non-expanding state is greater than the length of the circumference of the elastic webbing 20 in the non-expanding state in the embodiment, furthermore, the present invention is not restricted thereto. For example, the fabric 10 itself also has elasticity. In the case in which the fabric 10 capable of being expanded equivalently to or more than the elastic webbing 20 is used, therefore, the lengths may be set to be substantially equal to each other.

On the other hand, in the case in which the elastic webbing 20 has higher elasticity than the fabric 10, it is preferable to enable expansion of the elastic webbing 20 beyond the limit of the expansion of the fabric 10. In other words, it is preferable that the length of the circumference of the end of the fabric 10 should be set to be greater than the length of the circumference of the elastic webbing 20 and sewing to the elastic webbing 20 should be performed with the peripheral edge portion 11 of the fabric 10 loosened as in the embodiment.

In addition, the embodiment is only illustrative for concreteness to carry out the present invention and the technical scope of the present invention should not be thereby construed to be restrictive. In other words, the present invention can be carried out in various configurations without departing from the gist or main features thereof.

### EXPLANATION OF DESIGNATION

10 fabric
11 peripheral edge portion
12 opening portion
13 fold
20 elastic webbing

1. A headphone cover obtained by folding a peripheral edge portion of an elastic fabric back to one of surface sides over an entire periphery and forming an opening portion on the one of surface sides,
wherein an elastic webbing is sewn, with a thread, to a fabric in an opening peripheral edge portion corresponding to a peripheral edge of the opening portion.

2. The headphone cover according to claim 1, wherein a length of the thread is greater than a length of the entire periphery in a state in which the elastic webbing is contracted most greatly.

3. The headphone cover according to claim 2, wherein the thread is sewn in almost parallel with a longitudinal direction of the elastic webbing.

4. The headphone cover according to claim 2, wherein the thread is sewn in zigzags at a predetermined angle in a longitudinal direction of the elastic webbing.

5. The headphone cover according to claim 1, wherein a size is set in such a manner that a length of an entire periphery of an end of the fabric in a non-expanding state is greater than a length of the entire periphery in a state in which the elastic webbing is contracted most greatly.
